(19) United States
(12) Patent Application Publication
(10) Pub. No.: US 2013/0025098 A1
(43) Pub. Date: Jan. 31, 2013

(54) RATCHET STRAP TENSIONER

(71) Applicant: Michael John SMITH, Tamworth (GB)

(72) Inventor: Michael John SMITH, Tamworth (GB)

(21) Appl. No.: 13/559,022

(22) Filed: Jul. 26, 2012

(30) Foreign Application Priority Data
Jul. 26, 2011 (GB) 1112792.5

(51) Int. Cl. B60P 7/06; B25B 25/00

(52) U.S. Cl. 24/68 CD

(57) ABSTRACT

A ratchet strap tensioner and methods of using the same where the ratchet strap tensioner comprises a first arm pivotally mounted to a second arm by means that include a bush member which allows pivotal movement of the first arm relative to the second arm subject to the restraint of a ratchet mechanism; and further comprising a two-part winding spindle located partly within the bush member; the first part of said winding spindle being fixed to said bush member and the second part of said winding spindle being adapted to allow lateral movement (with respect the winding axis) from a closed position alongside said first part to an open position and thereby allow a strap to be attached without threading the strap through the tensioner and without bending the strap.

### TECHNICAL FIELD

The present invention relates to a ratchet strap tensioner which is primarily used for tightening the straps which are used to secure loads on commercial vehicles.

### BACKGROUND ART

Ratchet strap tensioners are well known, particularly in the transport field, commercial vehicles loaded with goods often use ratchet strap tensioners to tighten and secure straps which are employed to secure the load to the vehicle. By far the most common ratchet strap tensioners comprise a device having a short hook equipped strap permanently fixed to the tensioner and a second long hook equipped strap which is fed through a winder spindle.

In use, the said short strap which is permanently attached to the tensioner is hooked on to the vehicle. The long strap is then also hooked to the vehicle and passed over the load and through a slot in the tensioner winder spindle. Surplus strap is then pulled through the spindle until tight, then a lever handle on the tensioner is operated backwards and forwards against a ratchet to wind the strap around the spindle and so fully tighten the strap.

A typical example of such a tensioner can be found in U.S. Pat. No. 4,199,182 (Sunesson). Other examples of prior art can be found in U.S. Pat. No. 5,855,045 (Miura) and U.S. Pat. No. 5,943,742 (Huang); these are typical of the many patents in this field. In these examples the ratchet tensioner has a short main body; a longer operating handle; and a strap is tensioned by winding around a spindle.

The operation of these examples is similar. In use, a short main body is attached via a short strap to the vehicle and a longer strap is fed through the spindle which is known as the strap winding spindle which also provides the pivot point between the short main body and the long ratchet handle.

A pair of ratchet wheels are mounted on the winding spindle. A drive plate, which is slidably mounted in the operating handle is urged towards the ratchet wheels by a spring. The handle is then rotated, the drive plate engages with the teeth on the ratchet wheels and pulls the ratchet wheel round which in turn rotates the winding spindle.

If a belt has been passed through the winding spindle the belt is wound on to the winding spindle and thus the belt is shortened and therefore tightened. A handle is provided to release the ratchet by pulling the drive plate out of engagement with the ratchet wheels.

The disadvantage with these examples is that in use the long strap has to be fed through a slot in the centre of the winding spindle. The spare strap is then manually pulled through. It is quite common to find people walking backwards away from the vehicle in order to pull through surplus strap length before the ratchet mechanism can be brought into use.

Apart from the obvious difficulty in pulling through the surplus length of strap the dangers of an accident occurring to anyone walking backwards away from a vehicle; in order to thread through surplus strap and takeout twists along the strap is quite significant.

### DISCLOSURE OF THE INVENTION

The invention allows the insertion and removal of a strap to and from the ratchet strap tensioner without the need to thread long lengths of spare strap through the body of the tensioner assembly and advantageously without bending (for. example in a U-shape) the strap during insertion within a winding spindle.

In one aspect the invention comprises a ratchet strap tensioner having a first arm pivotally mounted to a second arm by means that include a bush member which allows pivotal movement of the first arm relative to the second arm, subject to the restraint of a ratchet mechanism; and further comprising a two-part winding spindle located partly within the bush member; the first part of said winding spindle being fixed to said bush member and the second part of the winding spindle being adapted to allow movement from a closed position alongside said first part to an open position.

Preferably, when in the open position, the second part of the spindle has been withdrawn at, least partly, through said bush member. More preferably, when in the open position, the second part of the spindle has been withdrawn through said bush member but is prevented from being detached from said bush member by a longitudinal slot or channel within the second part of the spindle that is engaged by a pin, fixed to said bush member.

Typically the ratchet strap tensioner comprises two bush members where each end of the winding spindle may be located within a bush member and where in the open position the second part of the spindle has been withdrawn through one of said two bush members. Preferably, said pivot bush has a plurality of protrusions that engage corresponding apertures in said ratchet wheel. Preferably, said pivot bush has a plurality of arcuate-shaped protrusions around which said first arm and second arm side plates may, in use, pivot.

Preferably, the second part of the spindle is prevented from being detached from said bush member by a longitudinal slot or channel within the second part of the spindle that is engaged by a pin, fixed to said bush member.

Preferably, when the second part of the spindle is in the closed position it is secured to a bush member by a pivoting pin which engages a “U-shaped” aperture at one end of the second part of the spindle.

In a second aspect the invention comprises a method of attaching a ratchet strap tensioner to a strap (S) to be tensioned using a ratchet strap tensioner comprising a first arm pivotally mounted to a second arm by means that include a bush member which allows pivotal movement of the first arm relative to the second arm subject to the restraint of a ratchet mechanism; and further comprising a two-part winding spindle located partly within a bush the first part of said winding spindle being fixed to said bush and the second part adapted to allow movement from a closed position alongside said first part to an open position; the method comprising the following steps: (i) moving the second part of the spindle to the open position; (ii) before or after step (i) pivoting the first arm relative to the second arm so as to provide an open “U-shaped” formation into which a strap can be placed without bending; and (iii) positioning said strap (S) such that a side surface of the strap abuts against an internal face of said fixed spindle; moving said second spindle to the closed position so that the strap (S) is sandwiched between internal faces of said first spindle and the second spindle prior to winding the strap around the spindle by cyclic angular movement of the first arm relative to the second arm.

In a further aspect the invention comprises a method of detaching a ratchet strap tensioner from a tensioned strap (S) using a ratchet strap tensioner comprising a first arm pivotally mounted to a second arm by means that include a bush member which allows pivotal movement of the first arm relative to the second arm subject to the restraint of a ratchet mechanism; and further comprising a two-part winding spindle located partly within a bush the first part of said winding spindle being fixed to said bush and the second part adapted to allow movement from a closed position alongside said first part to an open position; the method comprising the following steps: (i) releasing the ratchet mechanism and unwinding the strap from around the spindle; (ii) pivoting the first arm relative to the second arm so as to provide an open “U-shaped” formation from which a strap can be subsequently removed without bending the strap (S); and (iii) moving the second part of the spindle to the open position to allow such removal of the strap (S).

One object of the present invention is to provide a ratchet tensioner assembly which can accept a strap at any point along its length without the need to feed the strap through a slot in the centre of the winding spindle. It is thought that an improvement of this nature will eliminate the need for operatives to walk backwards away from the vehicle in order to loosen or unthread the strap. It achieves this by eliminating the need to thread surplus strap through the mechanism. In the current health and safety environment therefore, the invention will prove to be a desirable alternative to conventional ratchet tensioner systems.

A further object of the present invention is to provide a ratchet tensioner assembly which can accept a strap without any need to bend the strap during attachment (for example in a U-shape).

There is provided a ratchet tensioner assembly consisting of a short main body which, in use, is attached via a short strap to the vehicle. A longer strap is fed through a spindle which is known as the strap winding spindle which also provides the pivot point between the short main body and the long ratchet handle.

A pair of ratchet wheels are mounted on the winding spindle. A drive plate, which is slidably mounted in the operating handle is urged towards the ratchet wheels by a spring. When the handle is rotated, the drive plate engages with the teeth on the ratchet wheels and pulls the ratchet wheel round which in turn rotates the winding spindle to which they are affixed. A handle is attached to the drive plate to release the ratchet so that by manually pulling on the handle the drive plate is pulled out of engagement with the ratchet wheels.

In one aspect of the invention is characterised by the fact that the winding spindle is split into two parts a first fixed part and a second removable part. In use the removable part is withdrawn exposing the centre of a slot in the winding spindle in order to allow insertion of the strap at any point along its length. When the strap is in position the removable portion is replaced thus trapping the strap in the centre of the winding spindle at which point the operating handle can be moved to tighten the strap by winding it on to the winding spindle.

Bearing bushes are provided to connect the main body handle portion the a main arm portion and the fixed (first portion) part of the winding spindle connects the left and right hand bushes.

In a further aspect the invention comprises ratchet strap tensioner having a first arm pivotally mounted to a second arm by means that include a bush member which allows pivotal movement of the first arm relative to the second arm subject to the restraint of a ratchet mechanism; and further comprising a two-part winding spindle located partly within the bush member; the first part of said winding spindle being fixed to said bush member and the second part of said winding spindle being adapted to allow lateral movement (with respect the winding axis) from a closed position alongside said first part to an open position and thereby allow a strap to be attached without threading the strap through the tensioner and without bending the strap.

The methods of the invention may be used with various embodiments of the apparatus of the present invention.

### BRIEF DESCRIPTION OF THE DRAWINGS

The present invention is illustrated by the following diagrammatic figures in which:

FIGS. 1 and 2 show perspective views of a preferred embodiment of the invention in two different opened positions;

FIGS. 3 and 4 show perspective views of a preferred embodiment of the invention in a two different closed positions;

FIG. 5 is an exploded part diagram of the ratchet strap tensioner shown in FIG. 1;

FIG. 6 is a perspective view of the ratchet strap tensioner shown in FIG. 1 with the spindle in a fully open position and adjusted to accept a strap for tensioning;

FIG. 7 shows further details of the spindle assembly; and

FIGS. 8 and 9 show an alternative embodiment of the present invention.

### BEST MODES FOR CARRYING OUT THE INVENTION

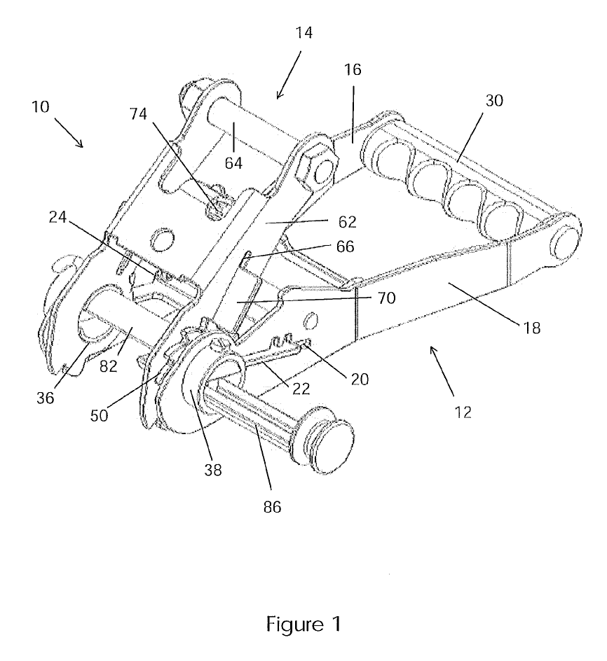

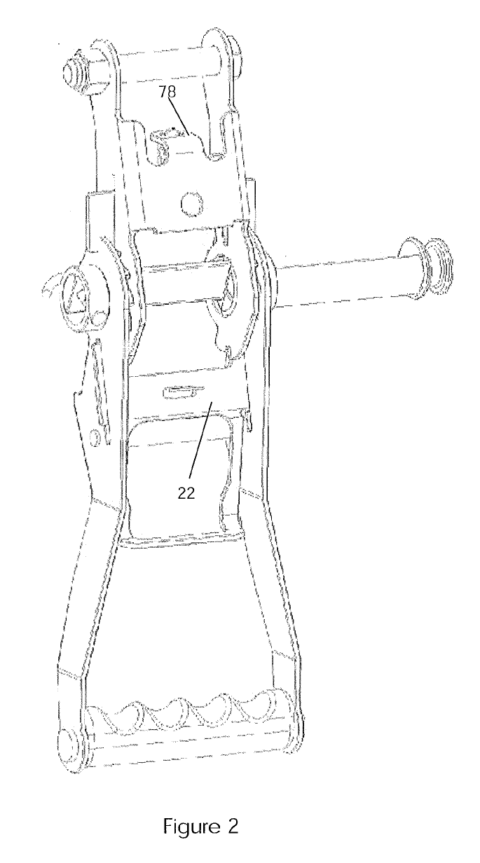

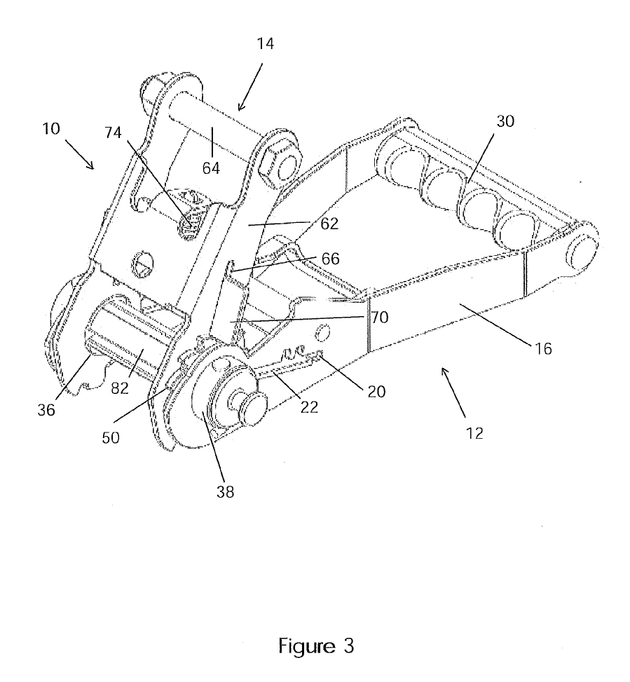

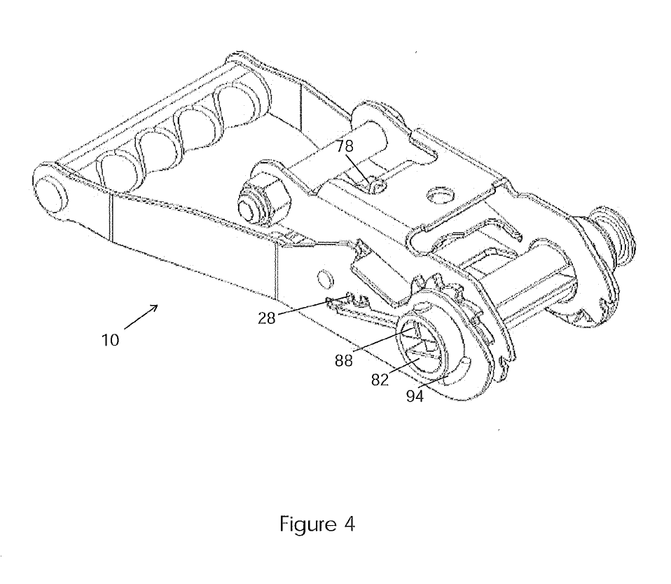

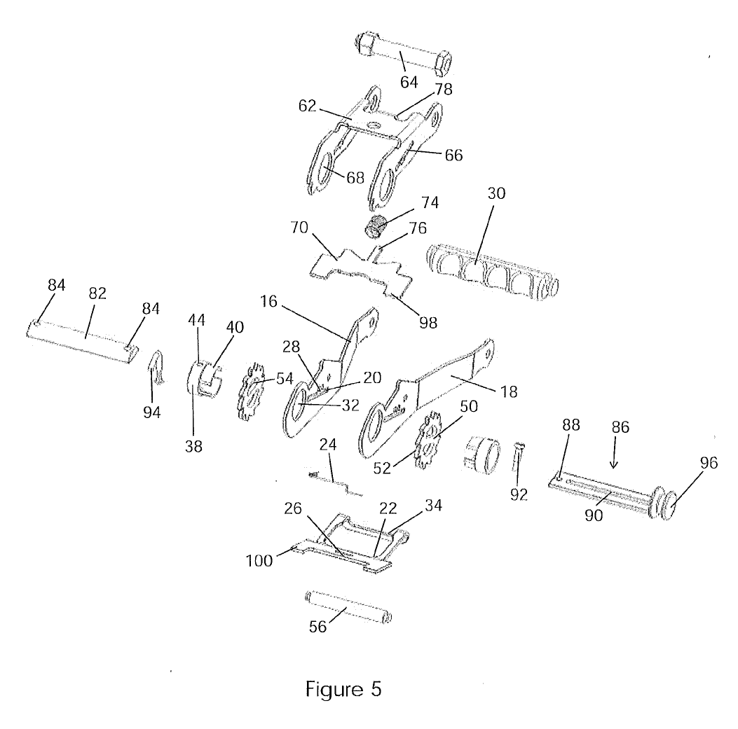

FIGS. 1-7 illustrate a ratchet strap tensioner according to a preferred embodiment of the present invention. FIG. 1 shows a perspective view of the tensioner (10) in a partly open positions; FIGS. 2 shows a perspective view of the tensioner (10) in a fully open positions (in preparation for receiving a strap); and FIGS. 3 and 4 show perspective views of the tensioner (10) in closed positions. FIG. 5 is an exploded part diagram of the tensioner (10).

The ratchet strap tensioner (10) comprises two main parts: a main body handle portion (12) and a main arm portion (14).

The main body handle portion (12) comprises a pair of side plates; a left hand side plate (16) and a right hand side plate (18). Each of these side plates (16, 18) comprises a front flat portion with a circular aperture (32) and a handle slider plate slot (20). One of the side plates (at least) has a pair of slide plate spring slots (28) that in use engage a coiled (first) end of a handle slider plate spring (24). Thus, a handle slider plate (22) is slidably mounted within and between the handle slider plate slots (20) and is biased in a forward (towards aperture 32) position by means of the slider plate spring; the second (L-shaped) end of the slider plate spring (24) engages a slot (26) in the handle slider plate (22). The handle slider plate has a handle portion (30) that a user may grip. In use, the handle portion (12) is pulled backwards (away from the apertures 32) in order to release the tensioner. Each handle side plate (16, 18) also has a flat angled portion, situated between the front flat portion and a rear flat portion; the rear flat portion being in a parallel plane to the front flat portion. The two side plates (16, 18) are held as described above by a handle (30) attached there-between and located near the end of the rear flat portion; the handle (30) acting as a first bracing spacer bar; a second bracing spacer bar (56) being attached between the front flat faces of the side plates (16, 18).

The main arm portion (14) is built around an arm frame (62) that has two side plates each with an arm slider plate slot (66) and a circular aperture (68). The two side plates of the arm frame (62) are held in side by side configuration by a (perpendicular) intermediate upper portion; thus in part the arm frame has a U-shaped cross section comprising the two side plates and the upper portion. The upper portion has an arm spring retainer member (78) comprising a bent tab with an aperture. An arm slider plate (70) is slidably mounted within and between the arm slider plate slots (66) and is biased in a forward position (towards circular apertures 68) by means of a coiled arm slider plate spring (74). The arm slider plate (70) has a spring locator (76) that comprises an extending member the function of which is to hold a coiled arm slider plate spring (74) in place such that one end of this spring (74) abuts against the main body of the slider plate (70) and the other end abuts against the bent tab (78) spring retaining member. Attached between rear extending sides of the arm frame (62) is a hook strap bolt (64) with a retaining nut.

The main body handle portion (12) and the main arm portion (14) are pivotally connected to each other such that in use the main body portion may be pivot (relative to the main handle portion 12); said pivoting being around the pivot portions (40) of a pair of pivot bushes (38); said pivot portions being housed within the circular apertures (32) of the side plates (16, 18) and the circular apertures (68) of the arm frame (62) side plates. These apertures (32, 68) are of equal diameter. The pivot portions (40) of each pivot bush (38) preferably comprise two arcuate members each with a radius equal (or slightly less) than the radius of apertures 32 and 68. Mounted on each of pivot portions, between the (outer) side plates (16, 18) and the (inner) slide plates of the arm frame (62) there is a ratchet wheel (50) with teeth (52). The ratchet wheels (50) have two D-shaped apertures (54) through which the pivot portions (40) of the pivot bush (38) pass. The pivot bushes and ratchet wheels are held in place by a fixed spindle portion (82) which has fixing holes (84) near each end and is fixed (see below) by a bolt or pin to each pivot bush (38). The fixed spindle portion (82) has a D-shaped cross section and is configured to fit snugly within a D-shaped aperture (54) of the ratchet wheel (50). Thus, in use, as the ratchet wheels (50) are turned the fixed spindle portion (82) will also correspondingly turn.

The winding spindle comprises a second portion (86) that in use may be retracted (normally by sliding) from its normal fixed position between the arm frame (62) side plates. The sliding spindle (86) comprises an elongate portion of D-shaped cross section and is configured to fit snugly within a D-shaped aperture of the ratchet wheel (50). The elongate portion of the sliding spindle (86) has a retaining key-hole (88) at a first end and an elongate guide groove (90) along most of the remainder of its length and leads (at the second end) to an integral knob (96) that in use is gripped by a person to move the sliding spindle located at the second end. Thus, in use, as the ratchet wheels (50) are turned the fixed spindle portion (82) will also correspondingly turn. A fixing/guide bolt (92) is provided within the right hand pivot bush the thread of which passes through a fixing hole (84) of the fixed spindle portion (80) thus holding it in place; and where the (conical) end of the guide bolt (92) engages the guide groove (90), guiding the sliding spindle (86) as it moves but preventing its detachment from the bush (38). A pivoting peg (94) with a pair of flat parallel faces (96) along part of its length is provided in order to engage a U-shaped retaining key-hole aperture (88) and thus lock the sliding spindle (by pivoting the peg) in place when it is in its fully inserted position (see FIGS. 1 and 2).

The teeth (52) of the ratchet wheels (50) are engaged by end jaws (98) of the arm slider plate (70) and also normally by the end jaws (100) of the handle slider plate (22)—unless the handle (34) of the arm sliding plate (22) has been withdrawn (away from apertures 32) by a user; for example, during detachment of the tensioner from straps.

The Ratchet Strap Tensioner described above may advantageously be connected to a strap without the need of threading the strap through the tensioner or bending the strap. A short (hook) strap is normally permanently attached to the hook strap bolt (64); in use the free end of this strap will be hooked to a first anchor point (for example on a transport vehicle). A second (long) strap will be hooked to a second anchor point and this strap will be placed over a load to be secured prior to being attached to the first strap by means of the ratchet strap tensioner which will then be used to tension the first and second straps so that they are taught and firmly secure the load. In use it is necessary for the second strap to be wound onto the spindle (80, 82) during the above described tensioning step.

Most tensioners require the long second strap to be threaded through a gap in a tensioner spindle. This is inconvenient and can be dangerous for an operator. Indeed even bending the second strap (in a U-shape) to attach it to a spindle can be difficult; especially with heavy gauge straps.

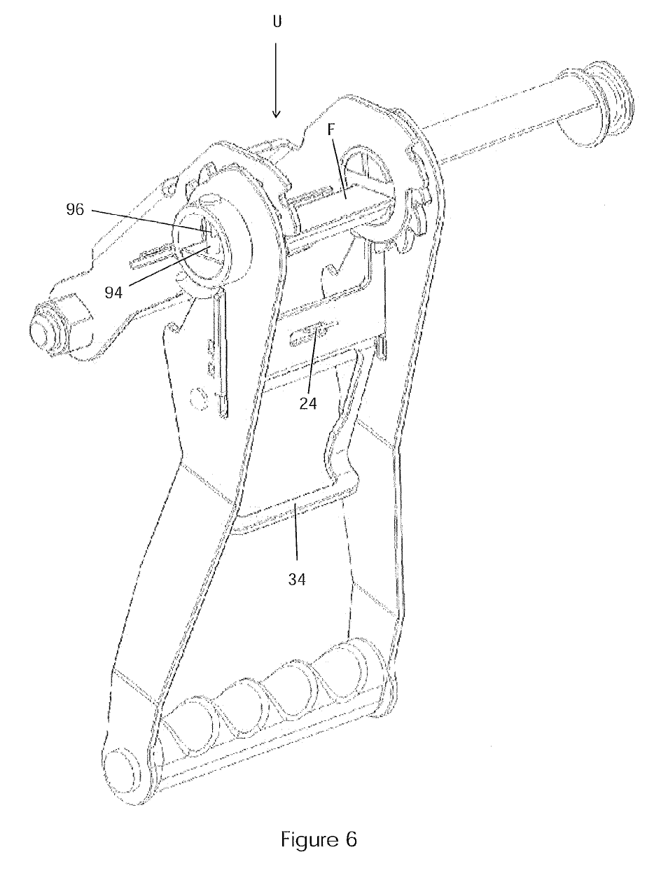

In the present invention the tensioner (10) is conveniently connected to the second strap by positioning the main body handle portion (12) and main arm portion (14) such that they are inclined at an acute angle to one-another (see FIG. 6); for example at an angle of 20-30° with the sliding spindle portion (86) fully withdrawn, so as to provide an open “U-shaped” formation (U) (see FIG. 6) into which a strap (not shown) can be placed without bending such that a side surface of the strap abuts against an internal face (F) of said fixed spindle. Thus, a flat face (F) of the fixed spindle portion (80) is positioned against the flat surface of the second strap without any need to thread or bend the second strap. The sliding spindle portion is the moved to the closed (retracted) position by means of a user gripping the integral knob (96) and locked in place by turning the pivoting peg (94) through an angle of about 90°. The user then (by means of handle (30) holds the tensioner (10) and angularly opens and closes the tensioner arms (cyclically) by pivoting the main body portion (12) handle away from and then towards the main arm portion (14); thus winding part of the second strap onto the spindle (88, 86). During this process the handle slider plate (22, 100) and the arm slider plate (70, 98) engage the sawtooth teeth (52) of the ratchet wheels to provide the required ratchet effect.

Thus, in use, the drive plate (22), that is slidably mounted in the operating handle (12) is urged towards the pair of ratchet wheels (50, 54), mounted on the winding spindles and bushes (82, 86, 38) by the spring (24). When the handle (12) is pivoted relative to the arm (14), the drive plate (22) engages the teeth (52) on the ratchet wheels and turns the ratchet wheel, which then turns the winding spindles (82, 86) to which they are affixed.

On completion of the operation the ratchet can be detached from the second strap merely by a user pulling release handle (34) of the handle slider plate backwards (away from the apertures 32) in order to disengage the slider plate end jaws (100) from the teeth (52) of the ratchet wheels (50); thus releasing the ratchet and allowing the spindle to freely rotate until none of the second strap is wound around it; at that point the sliding spindle portion can be easily withdrawn allowing removal of the tensioner; again (and advantageously) without any need to bend the second strap of to unthread the second strap from the tensioner.

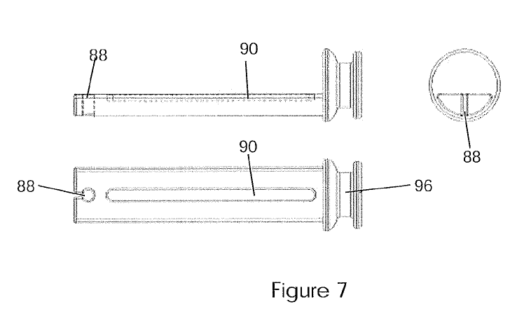

FIG. 7 shows three elevation views of the second part (86) of the winding spindle.

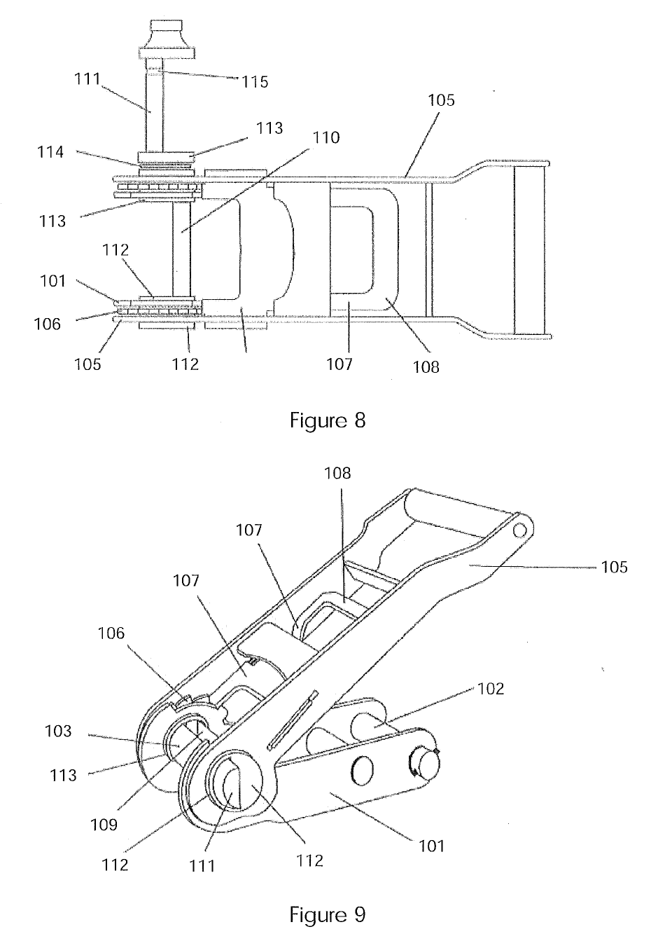

FIGS. 8 and 9 illustrate a ratchet belt tensioner according to a further embodiment of the invention. A main body 101 is equipped with an attachment spindle 102, to which a short strap (not shown) is attached. A longer strap (not shown) is fed through a winding spindle 103 which also provides the pivot point 103, between the short main body 101, and the long operating handle 105.

A pair of ratchet wheels 106, are mounted on either side of the winding spindle 103. A drive plate 107, is slidably mounted in the operating handle 105, and is urged towards the ratchet wheels 106 by a spring (not shown).

When the handle 105 is moved away from the main body 101, the drive plate 107 engages with the teeth on the ratchet wheels 106, and pulls the ratchet wheel 106 round. The ratchet wheel is attached to the winding spindle 103 therefore this action in turn rotates the winding spindle 103. In use when a strap is threaded through cavity 109 in the winding spindle 103, rotation of the spindle shortens the strap thus tightening it on the load to be secured. Part of the winding spindle 103 is permanently retained within the assembly by a retaining pin (not shown).

A handle 108 is attached to the drive plate 107 to release the ratchet so that by manually pulling on the handle 108, the drive plate 107, is pulled out of engagement with the ratchet wheels 106.

The winding spindle (103) is split into two parts a first fixed part 110 and a second removable part 111. In FIG. 8 the removable part 111 is withdrawn exposing the centre of a slot 109 (shown in FIG. 9) in the winding spindle in order to allow insertion of the strap at any point along its length. When the strap is in position the removable portion 111, is replaced trapping the strap in the centre slot 109 of the winding spindle at which point the operating handle 105 can be moved away from main body 101 to tighten the strap by winding it on to the winding spindle.

Normally, removal of the winding spindle 103 would result in the mechanism coming apart since the winding spindle 103 is also the bearing for parts 101 and 105.

The invention provides bush 112 and bush 113 to connect the mechanism and act as a bearing for movement between main body 101 and handle 105. Winding spindle portion 110 is permanently fixed between bushes 112 and 113.

The removable portion 111, of the winding spindle has a groove 115 which engages with retaining spring 114 when inserted and there is a further groove (not shown) for the spring 114 to engage when the retractable portion 111, is withdrawn.

The ratchet wheel 106 is engaged by drive plate 107. Handle 108 is pulled to disengage the ratchet for easy unwinding.

There are many different possible embodiments of this invention but the core feature of a retractable winding spindle where one portion of the spindle is retractable lies at the core of the invention and is present in all embodiments.

1. A ratchet strap tensioner comprising:
a first arm pivotally mounted to a second arm by means that include a bush member which allows pivotal movement of the first arm relative to the second arm subject to the restraint of a ratchet mechanism; and
further comprising a two-part winding spindle located partly within the bush member; the first part of said winding spindle being fixed to said bush member and the second part of said winding spindle being adapted to allow movement from a closed position alongside said first part to an open position.

2. A ratchet strap fastener according to claim 1 where in the open position the second part of the spindle has been substantially withdrawn through said bush member.

3. A ratchet strap according to claim 1 where in the open position the second part of the spindle has been substantially withdrawn through said bush member but is prevented from being detached from said bush member by a longitudinal slot or channel within the second part of the spindle that is engaged by a pin, fixed to said bush member.

4. A ratchet strap according to claim 1 comprising two bush members where each end of the winding spindles may be located within a bush member and where in the open position the second spindle has been substantially withdrawn through one of said two bush members.

5. A ratchet strap tensioner according to claim 1 0 wherein said pivot bush has a plurality of protrusions that engage corresponding apertures in said ratchet wheel.

6. A ratchet strap tensioner according to claim 1 wherein said pivot bush has a plurality of arcuate-shaped protrusions around which said first arm and second arm side plates may in use pivot.

7. A ratchet strap according to claim 1 comprising two bush members where each end of the winding spindle may be located within a bush member and where in the open position the second spindle has been substantially withdrawn through one of said two bush members but is prevented from being detached from said bush member by a longitudinal slot or channel within the second part of the spindle that is engaged by a pin, fixed to said one of said two bush members.

8. A ratchet strap according to claim 7 wherein in the closed position the second part is secured to a bush member by a pivoting pin which engages a “U-shaped” aperture at one end of the second part.

9. A method of attaching a ratchet strap tensioner to a strap to be tensioned using a ratchet strap tensioner comprising a first arm pivotally mounted to a second arm by means that include a bush member which allows pivotal movement of the first arm relative to the second arm subject to the restraint of a ratchet mechanism; and further comprising a two-part winding spindle located partly within a bush the first part of said winding spindle being fixed to said bush and the second part adapted to allow movement from a closed position alongside said first part to an open position; the method comprising the following steps:
(i) moving the second part of the spindle to the open position;
(ii) before or after step (i) pivoting the first arm relative to the second arm so as to provide an open “U-shaped” formation into which a strap can be placed without bending; and
(iii) positioning said strap such that a side surface of the strap abuts against an internal face of said fixed spindle; moving said second spindle to the closed position so that the strap is sandwiched between internal faces of said first spindle and the second spindle prior to winding the strap around the spindles by cyclic angular movement of the first arm relative to the second arm.

10. A method of detaching a ratchet strap tensioner from a tensioned strap using a ratchet strap tensioner comprising a first arm pivotally mounted to a second arm by means that include a bush member which allows pivotal movement of the first arm relative to the second arm subject to the restraint of a ratchet mechanism; and further comprising a two-part winding spindle located partly within a bush the first part of said winding spindle being fixed to said bush and the second part adapted to allow movement from a closed position alongside said first part to an open position; the method comprising the following steps:
(i) releasing the ratchet mechanism and unwinding the strap from around the spindle;
(ii) pivoting the first arm relative to the second arm so as to provide an open “U-shaped” formation from which a strap can be subsequently removed without bending the strap; and
(iii) moving the second part of the spindle to the open position to allow such removal of the strap.

11. A ratchet strap tensioner according to claim 4 wherein said pivot bush has a plurality of protrusions that engage corresponding apertures in said ratchet wheel.

12. A ratchet strap tensioner according to claim 4 wherein said pivot bush has a plurality of arcuate-shaped protrusions around which said first arm and second arm side plates may in use pivot.
